(19) United States
(12) Patent Application Publication
(10) Pub. No.: US 2003/0031462 A1
(43) Pub. Date: Feb. 13, 2003

(54) Collection and accumlation system for packets with time information

(76) Inventors: Satoshi Katsuno, Tokyo (JP); Katsuyuki Yamazaki, Tokyo (JP); Toru Asami, Hiki (JP); Kiminori Sugauchi, Yokohama (JP); Kenichi Yoshida, Kitamoto (JP); Hiromichi Enomoto, Hadano (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 10/187,709

(22) Filed: Jul. 5, 2002

(30) Foreign Application Priority Data
Jul. 11, 2001 (JP) 2001-210250

(51) Int. Cl. H04N 5/92; H04N 5/781

(52) U.S. Cl. 386/65; 386/125

(57) ABSTRACT

A time stamping part and a packet storing part are separated from each other. To simplify data transfer from the time stamping part to the packet storing part, the time stamping part adds time information after a captured packet, and outputs the packet directly through a port for the packet storing part. The packet storing part captures all packets sent from the time stamping device regardless of their destinations, thereby preventing the time stamping part from performing extra processing.

### BACKGROUND OF THE INVENTION

1. Field of the Invention

The present invention relates to a packet capture system that accumulates packets constituting traffic flowing through a network together with capture time information.

2. Description of the Prior Art

The types and amount of packets flowing at a given point of a network are recorded and stored. On another occasion, they are analyzed to provide assistance for subsequent network design and re-creation of the network. An example of records taken is traffic of some types of data (e.g., Web information).

Conventionally, there has been a software-based capture device as a capture device for capturing packets flowing through a network for the above described purpose. UNIX (UNIX is a trademark of X/Open Company Limited in the US and other countries exclusively licensed) operating systems provide libraries capable of acquiring all packets received through network cards.

In addition to QoS (Quality of Service) measurement, there is a method for holding certain segments to identify the order of flowing packets in combination with time when the packets were captured. To capture the time, time of a packet capture device is obtained from a time server to use correct time, or time information sent from an artificial satellite of GPS is used to obtain correct time and the time is used to calculate a packet arrival time.

Although some applications append a time stamp to packets to indicate the order of the packets during packet sending, this does not relate directly to the above. Most applications do not append a time stamp to packets during packet sending.

For application of GPS-based synchronous time to IP traffic measurement, Internet Protocol Performance Metrics Working Group of IETF (The Internet Engineering Task Force) defines rules for traffic measurement of IP network. RFC2330 “Framework for IP Performance Metrics” created by the group describes collection metric for measurement of traffic flowing through a network, and introduces GPS-based time synchronization means in page 16. A device for capturing network traffic by use of time subjected to time synchronization by use of GPS is described in “Surveyor: An Infrastructure for Internet Performance Measurement” S.Kalidindi and M. J. Zekauskas, et al of INET'99.

With the above described capture tools, since packet acquisition, time information acquisition, and accumulation processing are performed primarily on one process or one device, the load of the processings increase. As a result, in the case where packets of a high-speed network are captured, the captured packets cannot be processed and it is difficult to append correct time information about packet capture, and in the worst case, the captured packets may be lost before being processed. Therefore, it is necessary to create a system configuration capable of rapidly performing the above processings.

Expansion of a network causes a change in loaded locations. Capture locations should be set at loaded locations. On the other hand, large volumes of capture data require a high-capacity disk to store, as a result of which a capture device itself becomes physically large. Therefore, it is difficult to move capture locations to desired ones.

The present invention is a system that stores time information and captured packets, wherein a time stamping part for appending time information after packet capture, and a packet storing part for storing packets with time information appended are provided separately from each other, and in time stamping, time information is obtained by a time generating device for time stamp, and the time information is appended after a captured packet to simplify time stamping on the packet.

Furthermore, the time stamping part only appends time information to transmit packets to a port of the storing part, whereby the load on the transmission of the packets with time information appended between the time stamping part and the packet storing part is removed.

### BRIEF DESCRIPTION OF THE DRAWINGS

FIG. 1 is a diagram showing the configuration of a time information appended packet collection system in first and second embodiments of the present invention;

FIG. 2 is a flowchart showing the operation of a time stamping device in the first embodiment of the present invention when receiving transfer data;

FIG. 3 is a diagram showing data flowing between the time stamping device and a packet storage device in the first embodiment of the present invention;

FIG. 4 is a diagram showing a relationship between a receive frame in the second embodiment of the present invention and a frame flowing between the time stamping device and the packet storage device;

FIG. 5 is a flowchart showing the operation of the time stamping device in the second embodiment of the present invention when receiving transfer data;

FIG. 6 is a diagram showing the configuration of the time information appended packet collection system in a third embodiments of the present invention;

FIG. 7 is a flowchart showing the operation of a router in the third embodiment of the present invention when receiving transfer data;

FIG. 8 is a diagram showing a relationship between a receive frame in the router in the third embodiment of the present invention and a frame flowing between the router and the packet storage device; and

FIG. 9 is a flowchart showing the operation of the router in the third embodiment of the present invention when receiving transfer data.

### DESCRIPTION OF THE PREFERRED EMBODIMENTS

Hereinafter, preferred embodiments of the present invention will be described using the accompanying drawings.

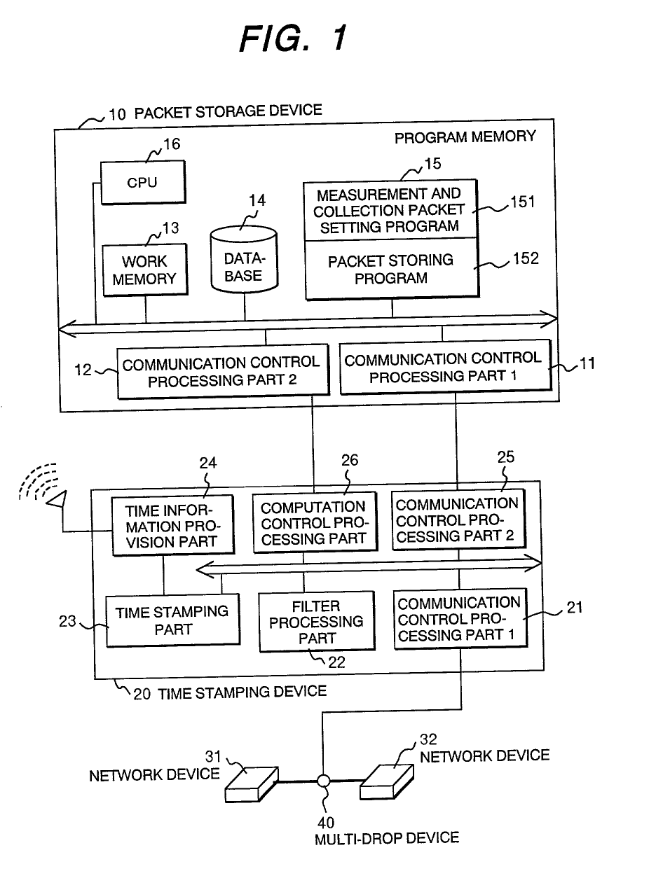

A first embodiment of the present invention will be described using FIGS. 1 to 3.

FIG. 1 shows a configuration of a time information appended packet collection and accumulation system based on the present invention.

In this embodiment, IP packets constituting traffic occurring between network devices (31, 32) are captured. Between the network devices is formed an Ethernet (Ethernet is a trademark of the US Xerox Corporation and is an example of a global network) network in which a multi-drop device (40) such as a hub and a splitter is inserted between the two network devices to measure traffic and Ethernet frames including IP packets are copied to the time stamping device (20). Or, passing packets may be directly received from either of the network devices (31, 32). Also in this case, the packets are copied within the network device.

A measuring system in this embodiment comprises a time stamping device (20) for capturing packets and stamping time information, and a packet storage device (10) for storing packets receiving to the time stamping device(20). In this way, the time stamping device and the packet storage device are provided separately from each other. The separate installation does not mean that housings are provided individually. It means that a function for capturing a packet and stamping a time, and a function for storing a packet stamped with a time are provided so that they can operate independently from each other. Information stored in the packet storage device (10) is used to reflect in network design, for example, by determining when what packets flow in what order in a network.

The time stamping device (20) comprises a communication control processing part 1 (21) for acquiring packets to be captured, a filter processing part (22) for judging whether a packet obtained through the communication control processing part 1 (21) is a necessary packet, a time stamping part (23) for stamping a time on a captured packet, a time information provision part (24) for obtaining a synchronized correct time by use of time synchronization based on time information from, e.g., GPS (Global Positioning System) or a time synchronous system employing NTP (Network Time Protocol) and presenting time information, a communication control processing part 2 (25) for sending a packet stamped with a time to the packet storage device (10), and a control processing part (26) for controlling the operation of processing in the time stamping 11 device (20). This embodiment assumes that a communication control processing part 1 (11) and a communication control processing part 2 (25) can handle Ethernet frames, and frames (large frames) of 1518 bytes or longer, which are MTU (Maximum Transmission Unit) of Ethernet frames.

The filter processing part (22) judges whether an obtained packet is a necessary packet, from the following purposes of capture. The following purposes are conceivable: analysis of only traffic flowing through a given server, analysis of traffic between given PCs, and analysis of what traffic exists on what applications.

The packet storage device (10) comprises a communication control processing part 1 (11) for controlling communications for collecting packets captured from the time stamping device (20), a communication processing part 2 (12) for passing filter conditions and the like to the time stamping device (20), a work memory (13), used as an operation area for program processing, for storing processing results, a database (14) for storing packets collected from a measuring device on each network device, a collection packet setting program (151) for setting filter conditions to restrict packets captured by the time stamping device (20), a program memory (15) for storing various programs such as a packet storing program (152), which stamps time information on captured packets and stores the packets in the hard disk (14), and a central processing unit (CPU) (16) for controlling access to the database and the program memory, and execution of programs.

The operation of this embodiment will be described.

When the time stamping device (20) is activated, the time information provision part (24) starts creating time information, using time synchronization means. For example, in the case where GPS is used as a method for synchronizing time information, time information transmitted by an artificial satellite is received, and when time information has become receivable at a given time interval, synchronized time information is created. Time information created by the time information provision part (24) is time information equal to or greater than second received from the artificial satellite; higher-resolution time information, that is less than second, is created by an internal clock. In this embodiment, a counter is provided which increases in increments of 100 n, and with a given value of the counter as a base, the counter increments up to one second, based on time information of the artificial satellite.

As another time synchronous system, for example, for use of the NTP version 3, at the time of activation, an NTP version 3 message is transmitted to a time server, and based on receive information obtained as a result, time information equal to or greater than second is collected. By periodically doing this, timing of carry greater than second is achieved to take synchronization. Higher-resolution time information is created by using an internal clock like the GPS.

After time information has been correctly created using the artificial satellite, the filter processing part (22) of the time stamping device (20) waits for reception of filter conditions for identifying a packet to be captured.

Filter conditions for packets are represented by a combination of one or more of conditions such as Ethernet address of packet transmitting source, Ethernet address of packet receiving destination, IP address of IP packet sending source, IP address of IP packet receiving destination, or subnet address of either of them, port number of sending source, and port number of receiving destination. Subnet denotes a smaller-size network connected to principal global networks.

In this embodiment, the measurement and collection packet setting program (151) of the packet storage device (10) passes filter conditions to the measurement control processing part (26) of the time stamping device (20) through the communication control processing part 2 (16) of the packet storage device (10).

The measurement control processing part (26) of the time stamping device, upon receiving the filter conditions, passes the filter conditions to the filter processing part (22). The filter conditions can be added, deleted, and changed not only during activation but also anytime through the measurement control processing part (26). On the other hand, the communication control processing part 1 (21) of the time stamping device (20) waits for reception to capture packets flowing through the network.

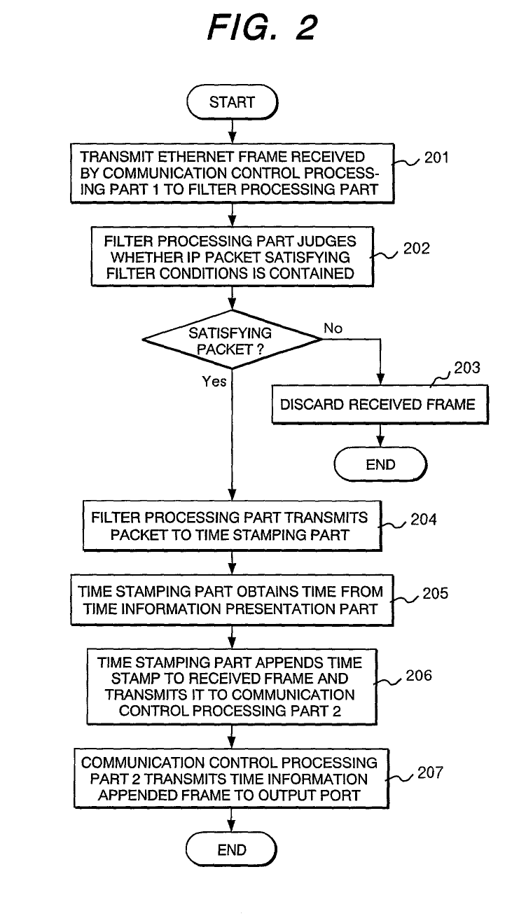

FIG. 2 is a flowchart showing the operation of the time stamping device (20) when capturing a packet.

The communication control processing part 1 (21), upon receiving an Ethernet frame, transmits the received frame to the filter processing part (22) (201).

The filter processing part (22) judges whether an IP packet (not limited to packets in this embodiment) contained in the received frame or the frame itself satisfies filter conditions set by the packet storage device (10) (202). If it does not satisfy the filter conditions, the filter processing part (20) discards the received frame (203). The received frame is a copy of a frame flowing through the network and exerts no influence on communications over the network. If the filter conditions are satisfied, the filter processing part (20) transmits the frame to the time stamping device (23) (204).

Upon receiving the frame from the filter processing part (22), the time stamping part (23) obtains time from the time information provision part (24) (205). The time stamping part (23) adds the obtained time information to the end of the received frame and transmits the time information appended frame to the communication control processing part 2 (25) (206).

Upon receiving the time information appended frame, the communication control processing part 2 (25) transmits it to an output port provided therein without modification (207).

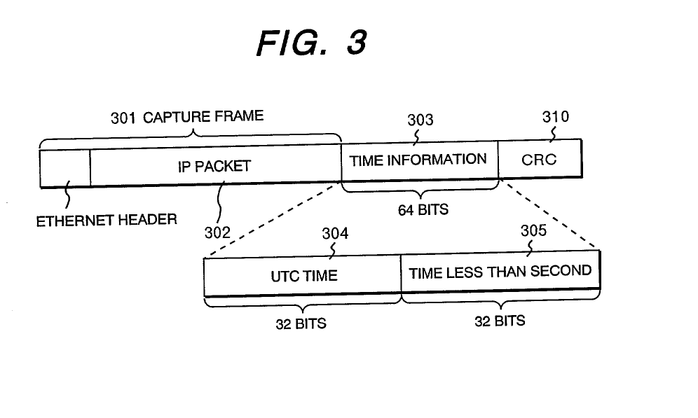

FIG. 3 shows the configuration of a time information appended packet transferred from the time stamping device (20) to the packet storage device (10). A captured frame (301) contains an IP packet (302) and is further added with time information (303) of 64 bits in length. Time information in this embodiment consists of time information (304) consists of time information equal to or greater than second and time information less than second (305). Time information equal to or greater than second is an elapsed time represented in seconds at the moment with 0:00:00, Jan. 1, 1970 of UTC (Coordinated Universal Time) as 0. CRC (Cyclic Redundancy Check) (310) is created in the communication control processing part for frame transfer and added.

The above is overall processing in the time stamping device (20).

The packet storage device (10), by making the state of receiving all Ethernet frames received in the communication control device 1 (11), can receive time information appended packets transmitted from the time stamping device (20) even if a lower layer address and a receive address of the packets do not point to the packet storage device (10) itself. This means the following. Ethernet frames flowing through the network contain the destination of the frames. The destination information does not specify the packet storage device (10). The time stamping device (20) does not change destination information of captured frames. The communication control device 1 (11) receives all frames transferred from an output port of the communication control processing part 25 whatever the destination information. Time information appended frames captured in the communication control device 1 (11) are stored in the database (14) by the packet storing program (152) without modification. These are analyzed as described previously and used to create a network.

Next, a second embodiment employing a method based on the present invention is described using FIGS. 1, 4, and 5. In this embodiment, not the whole of a packet to be captured but only a part of the packet is isolated and transferred to the packet storage device (10). This is because not all information within the packet needs to be stored to make the above analysis. For example, a packet contains a multilayer header. There are cases where a header representing the contents of data of the packet has only to be stored. Specifically, if a http header exists, it is recognized that Web information is transferred.

A system configuration in this embodiment is the same as that in the first embodiment.

System operations in this embodiment will be described.

The operation of the time stamping device (20) when activated is the same as that in the first embodiment, except for setting contents during setting of filter conditions.

As filter conditions passed from the packet storing device (10) to the time stamping device (20), in addition to conditions for determining whether IP packets from which IP packet transmission address, receive address, port number, and the like are received are satisfactory, as in the first embodiment, a range of packets to be captured can be specified in this embodiment.

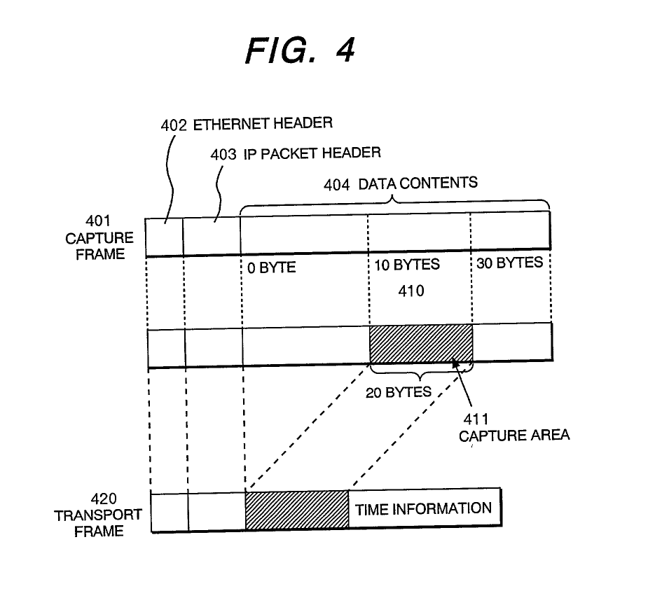

For example, as shown in FIG. 4, an Ethernet frame (401) includes Ethernet header (402), IP address header (403), and data contents (404) within IP packet. In this embodiment, by setting a header and the start position and end position of packet data as setting conditions, data contents within IP packets to be collected are retrieved. For example, if 20 bytes (411) from the first 10 bytes (410) of an IP packet are required as the contents of the IP packet, a start position is specified as 10 and length as 30. If 10 bytes are required as the contents of the IP packet, a start position can be specified as 0 and length as 10. As another specification method, with a start position omitted, only the length of bytes to be captured may be specified.

Upon receiving filter conditions from the packet storing device (10), the measurement control processing part (26) of the time stamping part (20) passes filter conditions on packet length within a frame transmitted to the packet storing device (10) to the time stamping part (23) and filter conditions for each packet shown in the first embodiment to the filter processing part (24).

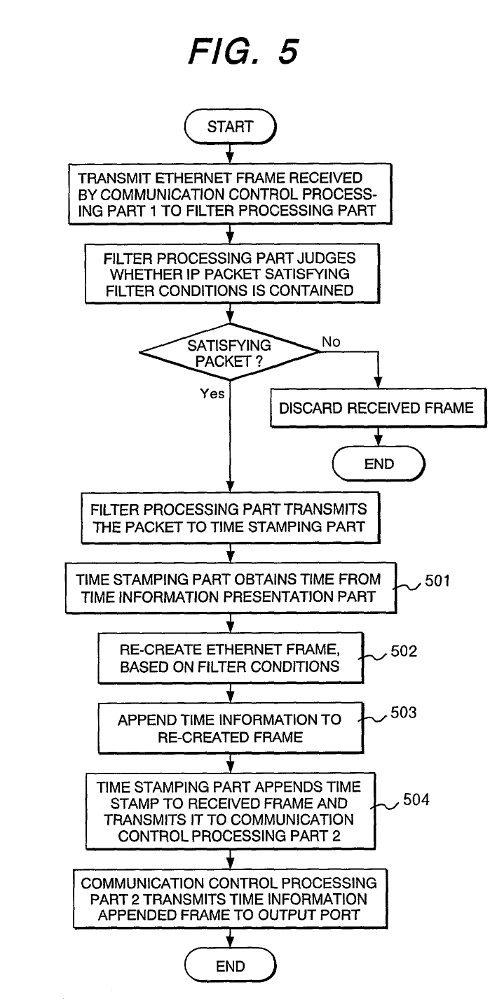

Next, the operation of the time stamping device when capturing an Ethernet frame is described. FIG. 5 is a flowchart showing the operation of the time stamping device when capturing a frame. No new step numbers are appended to steps having no distinct difference with those in FIG. 2 to omit or simplify descriptions.

In the time stamping device (20), except the operation of the time stamping part (23), the communication control processing part 1 (21), the filter processing part (22), the time information provision part (24), and the communication control processing part 2 (25) operate the same as those in FIG. 2.

Upon receiving a frame from the filter processing part (22), the time stamping part (23) obtains time information from the time information provision part (24) (501). After receiving time information, the time stamping part (23) splits the frame, based on an IP packet transmission position specified by the packet storage device (10), and deletes unnecessary contents to create an Ethernet frame for transmission (502). Thereafter, time information is appended to the re-created frame (503). The time stamping part (23) transmits the time information appended frame to the communication control processing part 2 (25) (504). A transfer frame (420) of FIG. 4 flows from the time stamping device (20) to the packet storage device (10).

In this embodiment, a transmission frame to the packet storage device (10) is created in the time stamping part (23). As another method, all filter conditions from the packet storage device (10) are transmitted to the filter processing part (22), which splits a frame satisfying filter conditions of the IP packet unit to create a transmission frame, and then transmits the transmission frame to the time stamping part (23). The time stamping part (23) operates the same as in the first embodiment.

The above is the operation of the time stamping device (20) in this embodiment.

The packet storage device (10) in this embodiment receives time information appended frames in the same way as in the first embodiment.

By the above method, a transfer amount of packets sent from the time stamping device to a capture device can be reduced. Since not all of captured packets are transmitted, it is difficult to perfectly recognize transfer data, providing data protection for network users.

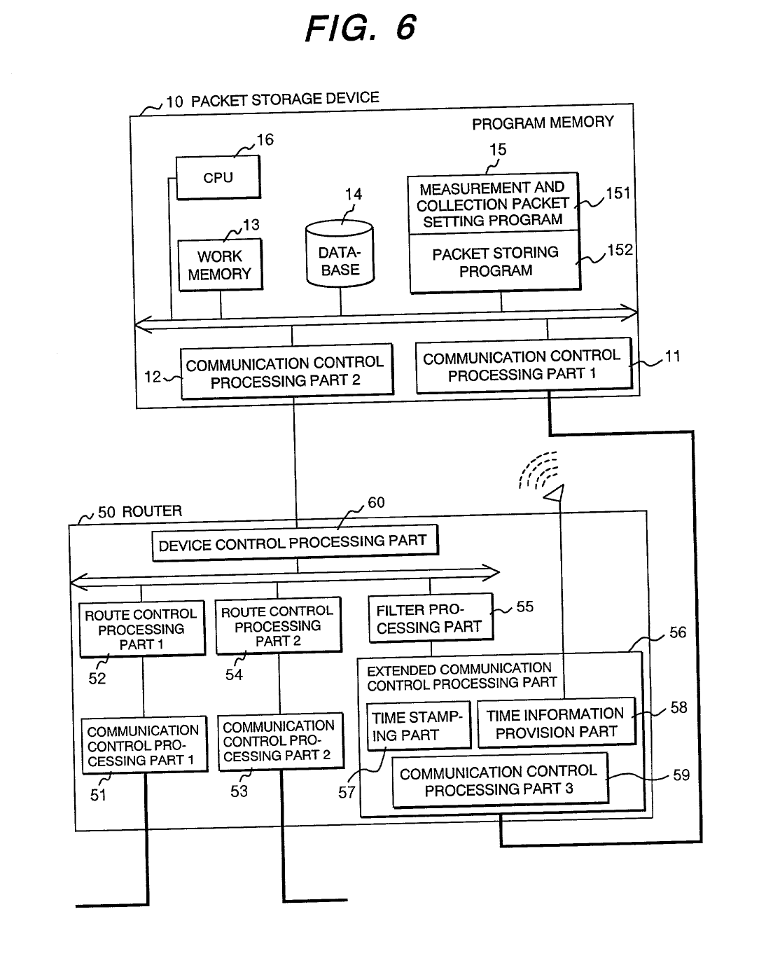

A third embodiment employing a method based on the present invention is described using FIGS. 6 to 8. In this embodiment, packets transferred on network devices such as a router are copied and the received data is transferred to a capture device.

FIG. 6 shows the configuration of a packet capture system based on the present invention. In this embodiment, the functions of the time stamping device (10) in the first embodiment are stored in a router (50) that is provided in the network and relays packets.

The router (50) has a communication control processing part 1 (51) and a communication control processing part 2 (53) for performing communications with other network devices, and transfers IP packets inputted from one of them to a specified network device through another communication control processing part. The communication control processing part is adaptable to various media and can receive Ethernet frames, OC-3 and OC-12 frames, and ATM cells.

An IP packet contained in a frame received in the communication control processing part 1 (51) is transferred or discarded by a route control processing part 1 (52), based on routing for deciding to what communication control processing parts individual input packets should be transmitted, and filter conditions. A device control processing part (60) accepts conditions for routing and filtering performed by the route control processing parts (52, 54) and passes them to the route control processing parts and other processing parts. The route control processing parts (52, 54) filter packets to be fed to the network for the reason of security and to limit traffic.

To capture packets, there are provided a filter processing part (55) for identifying packets to be captured, and an extended communication control processing part (56) for creating time information appended Ethernet frames to transmit to the packet storage device. The filter processing part (55) filters copies of packets that are inputted through the communication control processing part 1 (51) and outputted through the communication control processing part 2 (53). The extended communication control processing part (56) is provided with a communication control processing part 3 (59) for transmitting transfer data to the packet storage device (10), a time information provision part (58) for creating time information, and a time stamping part (57). The time information provision part (58) provides synchronized time by using time synchronous systems such as GPS and NTP.

In this embodiment, like the first embodiment, communications between the communication control processing part 3 (59) and the communication control processing part (11) are made using Ethernet frames; frames exceeding MTU are also handled.

The packet storage device (10) is the same as that in the first embodiment.

Although, in this embodiment, the route control processing parts (52, 54) exist for the communication control processing parts (51, 53), respectively, the two communication control processing parts (51, 53) maybe controlled by one route control processing part.

The operation of the router in this embodiment is described.

When the router (50) is activated, the time information provision part (58) in the extended communication control processing part (56) takes time synchronization by identifying an artificial satellite or communicating with an NTP server like the time information provision part (24) described in the first embodiment, and starts creating time information.

The device control processing part (60) within the router sets the route control processing parts (52, 54) to transfer received frames to the filter processing part (55). Thereafter, the device control processing part (60) waits to receive routing information for IP packet transfer, filter conditions during routing, and filter conditions for packet capture. The filter conditions for capture can be specified with the length of packet to be captured, in addition to combinations of IP addresses of transmission destination and source, port number, and the like, as in the first embodiment.

Upon receiving filter conditions for capture, the device control processing part (60) passes the filter conditions to the filter processing part (55) and the length of packet to be captured to the extended communication control processing part (56) through the filter processing part (55).

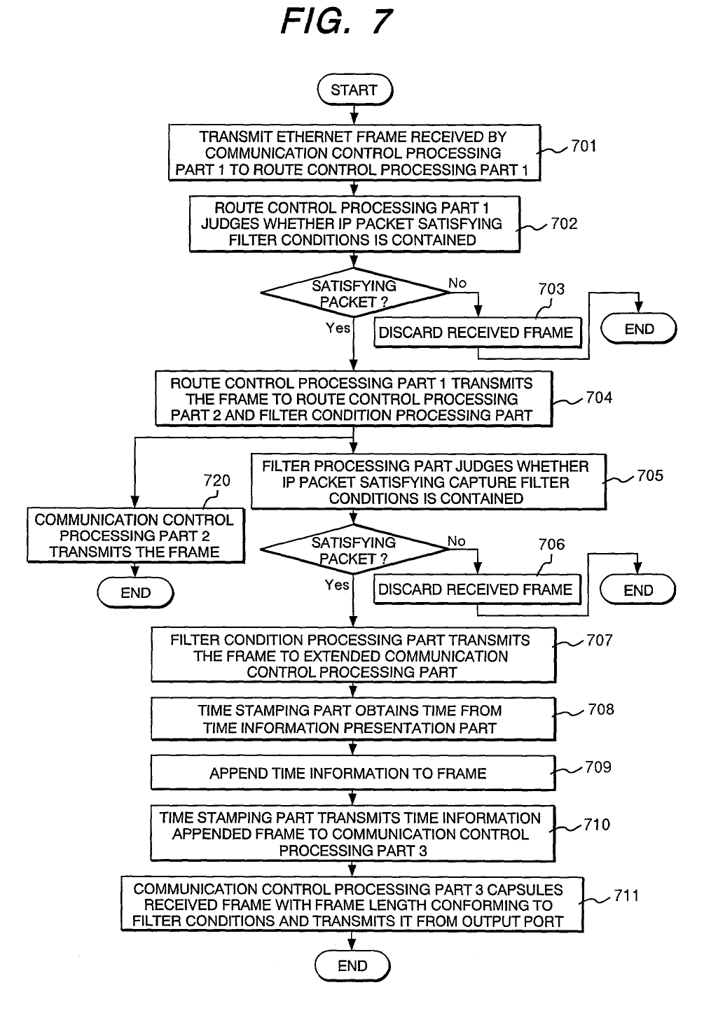

FIG. 7 is a flowchart showing the operation of the router when the communication control processing part 1 (51) receives a frame.

Upon receiving a frame, the communication control processing part 1 (51) within the router (50) transmits the received frame to the route control processing part 1 (52).

Upon receiving the frame, the route control processing part 1 (52) judges whether an IP packet contained in the frame satisfies the filter conditions (702). If it does not satisfy the filter conditions, the received frame is discarded (703). Filter conditions given to the route control processing part 1 (52) are security conditions described previously, unlike filter conditions for capture. The discarded received frame passes through the communication control processing part 2 (53) and is neither sent to the network nor transmitted to the filter processing part (55). If the filter conditions are satisfied, the communication control processing part 2 (54) of an output side is identified by header information of the IP packet and a routing table, and the received frame is transferred to the route control processing part 2 (54) corresponding to it. At this time, the route control processing part 1 (51) transmits the same frame to the filter processing part (55) for packet capture also (704).

The frame is transferred to a transmission destination via the route control processing part (54) and the communication control processing part 2 (53) (720).

Upon receiving the frame, the filter processing part (55) performs filtering to determine whether IP packet within the received frame is eligible for capture (705). The filter conditions are provided to extract packets required for measurement. If the filter conditions are not satisfied, the frame is discarded (706). If the filter conditions are satisfied, the frame is transmitted to the extended communication control processing part (56) (707).

Upon receiving the frame, the time stamping part (57) of the extended communication control processing part (56) obtains time information from the time information provision part (58) as in the first embodiment (708). The time information provision part (58) presents time information in the same operation as the time information provision part (24) of the first embodiment. Thereafter, the time stamping part (57) stores the time information before the received frame (709).

The time stamping part (57) transmits the frame added with the time information to the communication control processing part (59) (710). Upon receiving the frame, the communication control processing part 3 (59) stores the received frame in an Ethernet frame. The communication control processing part 3 (59) transmits only the frame with a packet length passed from the device control processing part (60) (711).

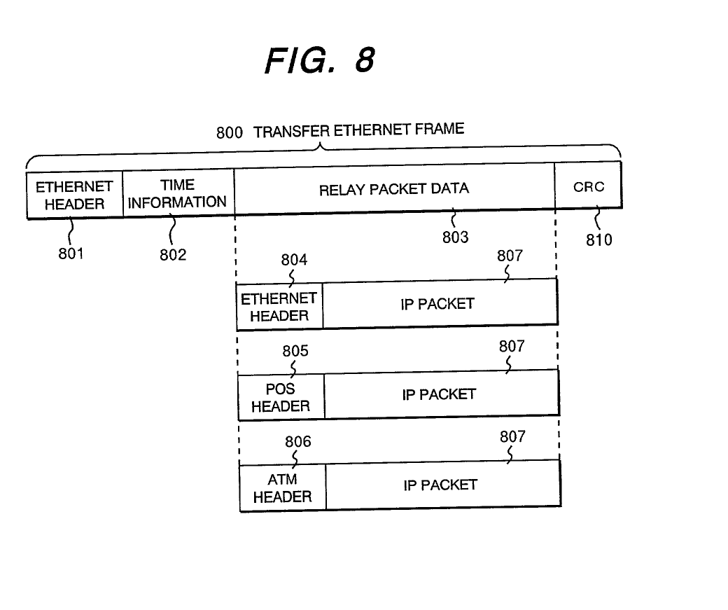

FIG. 8 shows a time information appended frame (800) transferred to the packet storage device. The leading Ethernet header (801) is a header for transmitting this frame to the packet storage device (10). Time information (802) has the same format as that in the first embodiment and contains UTC based second information and information less than second. In a receive frame (803), a frame received by the communication control processing part 1 (51) is stored, and one of Ethernet header (804), POS (Packet over SONET) header (805), and ATM (Asynchronous Transfer Mode) header is stored along with IP packet (807), depending on media of the communication control processing part 1 (51). CRC (810) is appended by the communication control processing part 3 (59) as in the first embodiment. This arrangement allows headers of different systems such as Ethernet header, POS header, and ATM header to be contained in an Ethernet frame and transferred, providing the flexibility of being adaptable to various types of networks.

The foregoing processing is performed in the same way even if the communication control processing part 2 (53) receives a frame. That is, the route control processing part 2(54) transfers the received frame to the route control processing part 1 (52), and at the same time transfers it to the filter processing part (55) also. Thereafter, the same processing (705 to 711) is performed in the filter processing part (55) and the extended communication control processing part (56).

The above is processing performed within the router. The packet storage device (10) receives an Ethernet frame in the same processing as in the first embodiment. In this case, since the receive MAC (Media Access Control) address of the Ethernet frame is correct, an Ethernet frame directed to the packet storage device itself has only to be captured.

The above described processing system and configuration enable an IP packet to be captured with header information of a lower layer appended, without relying on subordinate communication means. That is, even if headers of different types such as Ethernet Header (804), POS header (805), and ATM header (806) are included in Ethernet frames, the Ethernet frames can be handled in the same way.

Although, in this embodiment, filter conditions for transfer are checked in a route control processing part corresponding to a communication control processing part receiving a transfer frame, the filter conditions may be checked in a communication control processing part of a transmitting side. That is, if the communication control processing part 1 (51) receives a frame, instead of the route control processing part 1 (52) checking filter conditions, the route control processing part 2 (54) checks the filter conditions. If the communication control processing part 2 (53) receives the frame, instead of the route control processing part 2 (54) checking the filter conditions, the route control processing part 1 (52) checks the filter conditions. In this case, the filter processing part (55) is supplied with frames not filtered in the route control processing part (52 or 54).

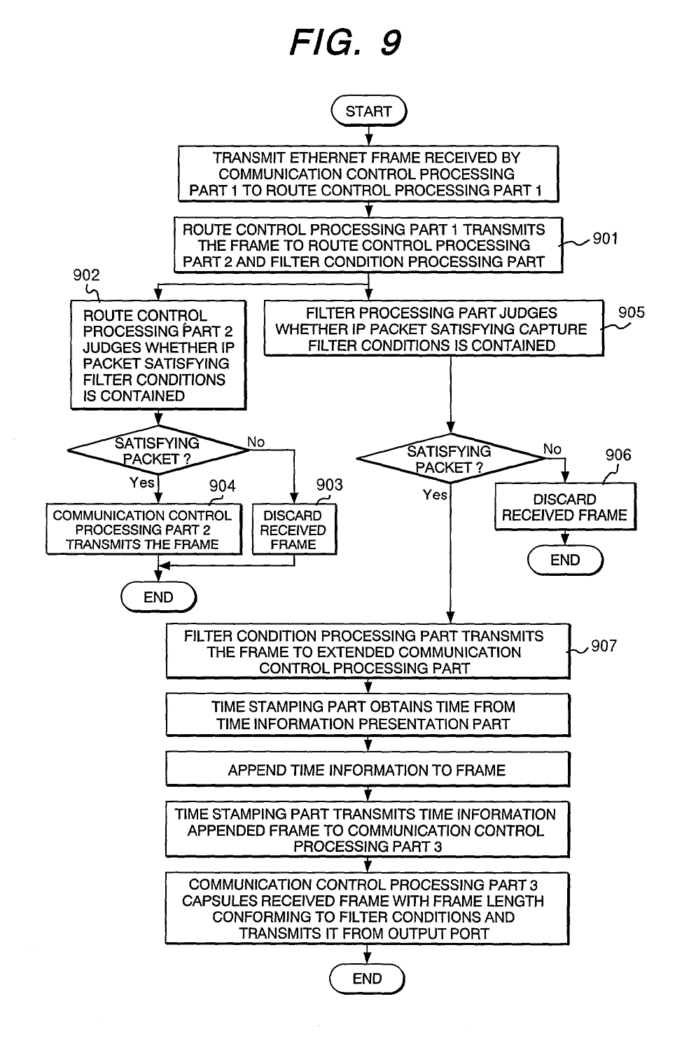

FIG. 9 is a flowchart summarizing the operation of the time stamping device in the above conditions. The route control processing part 1 (52) transfers a frame received by the communication control processing part 1 (51) to the route control processing part 2 (54) of output destination retrieved based on the filter processing part (55) and a routing table (901). The route control processing part 2 (54) judges whether filter conditions specified by the packet storage device are satisfied (902). The transferred frame is discarded if it does not satisfy the filter conditions (903). If it satisfy the filter conditions, an IP packet transferred by the communication control processing part 2 (53) is transmitted from an output port (904).

On the other hand, the filter processing part (55) judges whether the received frame satisfies filter conditions for capture (905). If it does not satisfy the conditions, it is discarded (906). If it satisfies the conditions, it is transmitted to the extended communication control processing part (56) (907). Thereafter, the extended communication control processing part (56) performs the same processing as in the first embodiment.

As a result, capture frames before filtering by filter conditions in the route control processing part (52 or 54) can be transferred to the filter processing part (55), and packets satisfying filter conditions in the route control processing part (52 or 54) can also be captured.

Furthermore, although, in this embodiment, the length of packets for capture is adjusted by the communication control processing part 3 (59), packet creation processing may be performed in the time stamping device (57) or the filter processing part (55) to transmit data in any location on an IP packet to the packet storage device, as in the second embodiment. In this case, as conditions on packet length for capture passed from the packet storage device (10), the same conditions in the second embodiment can be used. Also, in this case, time information may be placed after a created frame.

As a system configuration of this embodiment, although communications between the communication control processing part 1 (11) and the communication control processing part 3 (59) are achieved by Ethernet, for example, other transfer means such as fiber channel and SDH/SONET may also be used. In this case, the communication control processing part 1 (11) and the communication control processing part 3 (59) require transfer protocol suitable for transfer means mutually used. For example, if a fiber channel is used, in the case where receive frames are POS or ATM frames, a packet sent by one frame may exceed 2,112 bytes, which are the maximum length of data that can be stored in a frame, determined by FC-2 of fiber channel. For this reason, if the frame is received, the communication control processing part 3 (59) splits the received frame and the communication control processing part 1 (11) reassembles the split frame. For SDH/SONET, by providing a communication control processing part that can handle larger STM frames than can the communication control processing parts 1 (51) and 2 (53), received frames can be capsuled without modification to transmit.

According to this embodiment, a device to capture packets is separated into a time stamping device and a packet storage device, a maximum length of Ethernet frames between the time stamping device and the packet storage device is larger than a maximum length of packets captured by the time stamping device, and packets added with time information can be transferred to the packet storage device simply by adding the time information to the packets, without changing destination information in the frames, whereby a time stamping operation can be simplified and processing can be sped up.

By copying packets subjected to routing within the router and capturing the packets, the packets do not need to be branched from network lines for measurement, simplifying device facilities.

Because of no dependence on network media of low layers, data packets transferred through various network media can be captured in the same format.

Furthermore, the time stamping device is constructed so that the length of packets to be captured can be adjusted, whereby data size for capture can be reduced.

A device to capture packets is separated into a time stamping device and a packet storage device, a maximum length of Ethernet frames between the time stamping device and the packet storage device is larger than a maximum length of packets captured by the time stamping device, and packets added with time information can be transferred to the packet storage device simply by adding the time information to the packets, without changing destination information in the frames, whereby a time stamping operation can be simplified and processing can be sped up.

What is claimed is:

1. A time information appended packet collection and accumulation system, comprising:
a time stamping device having first means, connected to a network, for capturing packets flowing through said network, second means for providing time information, third means for appending said time information to captured packets, and fourth means for transmitting packets added with time information; and
a packet storage device, provided separately from said time stamping device, having fifth means for receiving packets transmitted from said fourth means, and sixth means for storing packets received by the fifth means.

2. The time information appended packet collection and accumulation system according to claim 1, wherein said third means, without re-creating a frame containing a captured packet, appends said time information after said frame.

3. The time information appended packet collection and accumulation system according to claim 2, wherein said fifth means receives information transferred from the fourth means regardless of a destination of the information.

4. The time information appended packet collection and accumulation system according to claim 1, wherein said fourth means has an output port for said fifth means, and said time stamping device, after appending time information to a captured packet, transmits the time information appended packet to said output port without changing additional information for transferring the packet.

5. The time information appended packet collection and accumulation system according to claim 1, wherein said fourth means and fifth means have a communication device conducting communication by transfer packets larger than a maximum packet length of transfer packets of captured packets.

6. The time information appended packet collection and accumulation system according to claim 1, wherein said packet storage device has seventh means for sending filter conditions indicating packets to be extracted by said first means to said first means.

7. The time information appended packet collection and accumulation system according to claim 1, wherein said packet storage device has a control part conducting control independently of said time stamping device, and said sixth means and seventh means operate under control of said control part.

8. The time information appended packet collection and accumulation system according to claim 1, wherein time information presented by said second means consists of a combination of time information equal to or greater than a given time unit and time information having a resolution higher than said time unit, and the respective time information is values counted with a given time in said time unit as a base.

9. The time information appended packet collection and accumulation system according to claim 1, wherein said first means extracts part of a packet according to conditions specifying the part of the packet, and transfers information containing the extracted part of the packet to the third means.

10. The time information appended packet collection and accumulation system according to claim 9, wherein said conditions specifying part of a packet are presented from said packet storage device.

11. The time information appended packet collection and accumulation system according to claim 9, wherein said conditions specifying part of a packet specify a length from the start of data contents of a captured packet, and said third means transmits information containing data contents of a specified length and time information, extracted according to said conditions, to said fourth means.

12. A time information appended packet collection and accumulation system, having a relay device for relaying packets flowing through a network, and a packet storage device for storing captured packets, wherein:
said relay device has a relay processing module for relaying packets, and a communication control module for collecting time information and appending it to said packets extracted according to given filter conditions;
said relay processing module has means for transferring packets subjected to relay processing to said communication control module; and
said communication control module further capsules received packets by a transfer protocol supported by said communication control module and transfers the capsuled packets to said packet storage device.

13. The time information appended packet collection and accumulation system according to claim 12, wherein:
said relay device also transfers transfer information required to transfer said packets to said network to the communication control module; and
said communication control module also capsules said received transfer information and transfers the capsuled transfer information to the packet storage device.

14. The time information appended packet collection and accumulation system according to claim 12, wherein said communication control module has means for extracting part of a packet according to conditions specifying an arbitrary location of a packet to be captured, and transferring information containing the extracted data to said packet storage device.

15. The time information appended packet collection and accumulation system according to claim 14, wherein said conditions specifying part of a packet specify a length from the start of data contents of a captured packet, and said communication control module transmits information containing data contents of a specified length, extracted according to said conditions, to said packet storage device.
